(19) United States
(12) Patent Application Publication
(10) Pub. No.: US 2016/0336089 A1
(43) Pub. Date: Nov. 17, 2016

(54) CARBON FIBER COMPOSITE HAVING HIGH CONDUCTIVITY AND METHOD FOR PREPARING THE SAME

(71) Applicant: Hyundai Motor Company, Seoul (KR)

(72) Inventors: Young Ho Choi, Seongnam (KR); Seok Hwan Kim, Suwon (KR)

(21) Appl. No.: 14/980,857

(22) Filed: Dec. 28, 2015

(30) Foreign Application Priority Data
May 15, 2015 (KR) 10-2015-0067965

(51) Int. Cl. H01B 1/24; C08K 7/06; C08K 9/02

(52) U.S. Cl. CPC H01B 1/24; C08K 9/02; C08K 7/06; C08K 2201/001

(57) ABSTRACT

Disclosed are a carbon fiber composite having high conductivity and a method for preparing the same. The carbon fiber composite may comprise a carbon fiber reinforcement material that includes a carbon fiber and a conductive metal-plated carbon fiber, such that the carbon fiber composite may be used when lightning occurs due to its high conductivity. Further, the carbon fiber composite may also achieve lightweight by using the carbon fiber.

### CROSS-REFERENCE TO RELATED APPLICATION

This application claims under 35 U.S.C. §119(a) the benefit of Korean Patent Application No. 10-2015-0067965 filed on May 15, 2015, the entire contents of which are incorporated herein by reference.

### TECHNICAL FIELD

The present invention relates to a carbon fiber composite having high conductivity and a method for preparing the same. In particular, the carbon fiber composite may comprise a carbon fiber and a conductive metal-plated carbon fiber. As such, the carbon fiber composite may reduce risks, when lightning occurs, due to its high conductivity by applying a carbon fiber reinforcement material, and may also achieve weight reduction by using the carbon fiber.

### BACKGROUND

A roof for a vehicle needs metal-level conductivity in order to protect passengers and the vehicle, for example, from lightning weather condition. However, when the conductivity is not enough, lightning current may not run along the vehicle shell, and a part of the vehicle body may be burn or broken by heating caused by resistance value. In order to prevent such damage, in the related arts, methods, for example, 1) a method of adding a metal mesh layer, 2) a method of coating a metal thin plate, 3) a method of wrapping with a metal fiber such as a reinforcement fiber of a composite material and weaving, 4) a method of forming a conductive path by adding a conductive filler to a composite material resin and the like, have been reported.

For instance, in the above method 1), metal mesh may have excellent effect, but may have problems of increase of internal residual stress and potential corrosion (aluminum mesh) after molding by insertion of heterologous material. For the method 2), the aluminum thin plate may deteriorate aesthetic impression and potential corrosion, and for the method 3), there are problems of difficulty of weaving of the fiber wrapped with the metal fiber, uneven thickness and damage of aesthetic impression of weaving pattern. Further, in the above method 4), when adding the conductive filler to the composite material resin, the metal filler may have problems of weight increase and difficulty of resin impregnation of a reinforcement mat, and when adding a CNT (SWNT, MWNT, VGCNF), price may increase substantially, as compared to improvement of conductivity.

On the other hand, as fossil fuel depletion and environmental problem have become issues, weight reduction of a vehicle is required. Accordingly, when a composite material contains a carbon fiber that has recently drawn attention as a weight reducing material, the vehicle may be exposed to danger, in particular in lightning condition because the composite material has 1,000 folds or less electrical conductivity than the conventional steel material.

In a certain example, Japanese Patent Laid-Open Publication No.2002-256153 disclosed a lightweight conductive molded body comprising a conductive fiber having average monofilament diameter of 1 to 50 μm and a resin. However, the molded body has disadvantages that setting of molding condition may be hard to express the optimum performance and reproducibility may be difficult because two kinds of resin are used to from a conductive path of the conductive fiber.

Further, Korean Patent Publication No.1286970 disclosed a polypropylene resin composition for shielding electromagnetic interference comprising a polypropylene resin, a fibrous filler containing a metal-coated glass fiber and a thermoplastic elastomer. However, the composition has a disadvantage that its mechanical properties are too poor to be used as a vehicle shell part such as a roof.

Further, US Patent Laid-Open Publication No.2003-0092824 disclosed a conductive thermoplastic composition comprising a polyphenylene ether copolymer, polyamide and a conductive filler. However, the composition has a disadvantage of thousands folds lower conductivity of the conductive filler, which prevents heating by lightning.

Thus, development of a novel material, which satisfies metal-level conductivity for protection from exposure to risk in the lightning environment and, at the same time, embody lightweight is need.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to solve the above-described problems associated with prior art.

In preferred aspect, the present invention provides a carbon fiber reinforcement material comprising a carbon fiber and a conductive metal-plated carbon fiber. The carbon fiber reinforcement material may increase conductivity, reduce risks when lightning occurs, and achieves weight reduction. Further, the carbon fiber composite may have high conductivity.

The “conductive metal-plated carbon fiber” as used herein refers to a carbon fiber which is further modified or treated to include a metal or a metal compound. For example, the metal components may be coated or plated on a surface of the carbon fibers, for example, by an electroless plating process, such that the surface of the carbon fibers can be coated or placed partially or entirely. The metal components may suitably include any alkali metals, alkali earth metals, transition metals, lanthanides and the like, without particular limitation. Exemplary metal components in the present invention includes a (Cu), zinc (Zn), silver (Ag), gold (Au), platinum (Pt), antimony (Sb), manganese (Mn), nickel (Ni), vanadium (V), indium (In), tin (Sn) and the like.

Further, the present invention provides a method for preparing the carbon fiber composite to achieve lightweight.

Further provided is a molded body comprising the carbon fiber composite.

Still further provided is a vehicle that comprises the molded body comprising the carbon fiber composite.

In one aspect, the present invention provides a carbon fiber composite having high conductivity. The carbon fiber composite may include a carbon fiber reinforcement material comprising a carbon fiber and a conductive metal-plated carbon fiber and a matrix resin impregnated on the carbon fiber reinforcement material.

The carbon fiber may have average fiber length of about 1 to 70 mm.

The a metal of the conductive metal-plated carbon fiber may be at least one selected from the group consisting of copper (Cu), zinc (Zn), silver (Ag), gold (Au), platinum (Pt), antimony (Sb), manganese (Mn), nickel (Ni), vanadium (V), indium (In) and tin (Sn).

The conductive metal may have average thickness of about 0.1 to 0.5 μm.

The carbon fiber reinforcement material may be in the form of a three-dimensional non-woven fabric.

The matrix resin may be a thermosetting resin that is at least one selected from the group consisting of epoxy, urethane, vinyl ester, unsaturated polyester and urethane acrylate. Alternatively, the matrix may be a thermoplastic resin consisting of nylon, polymethylmethacrylate (PMMA) or a mixture thereof.

The carbon fiber composite may further comprise the carbon fiber in an amount of about 10 to 30 volume %, the conductive metal-plated carbon fiber in an amount of 10 to 50 volume % and the matrix resin in an amount of 40 to 60 volume %, all the volume % based on the total volume of the carbon fiber composite.

In another aspect, the present invention provides a method for preparing a carbon fiber composite having high conductivity. The method may include: preparing a carbon fiber reinforcement material by steps comprising mixing a carbon fiber and a conductive metal-plated carbon fiber; and preparing the carbon fiber composite by steps comprising impregnating a matrix resin on the carbon fiber reinforcement material and then molding thereof.

The carbon fiber composite may comprise the carbon fiber in an amount of about 10 to 30 volume %, the conductive metal-plated carbon fiber in an amount of about 10 to 50 volume % and the matrix resin in an amount of about 40 to 60 volume %, all the volume % based on the total volume of the carbon fiber composite.

The molding may be conducted by wet compression molding or Sheet Molding Compound (SMC) process.

In still another aspect, the present invention provides a molded body comprising the carbon fiber composite. Exemplary molded body may include a lightweight roof for a vehicle.

Further provided is a vehicle that comprises the molded by comprising the carbon fiber composite.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 illustrates an exemplary carbon fiber composite including (a) an exemplary carbon fiber, (b) an exemplary conductive metal-plated carbon fiber and (c) an exemplary carbon fiber composite according to an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter reference will now be made in detail to various embodiments of the present invention, examples of which are illustrated in the accompanying drawings and described below. While the invention will be described in conjunction with various exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention provides a carbon fiber composite having high conductivity. The carbon fiber composite may comprise a carbon fiber reinforcement material comprising a carbon fiber and a conductive metal-plated carbon fiber and a matrix resin that may be impregnated on the carbon fiber reinforcement material.

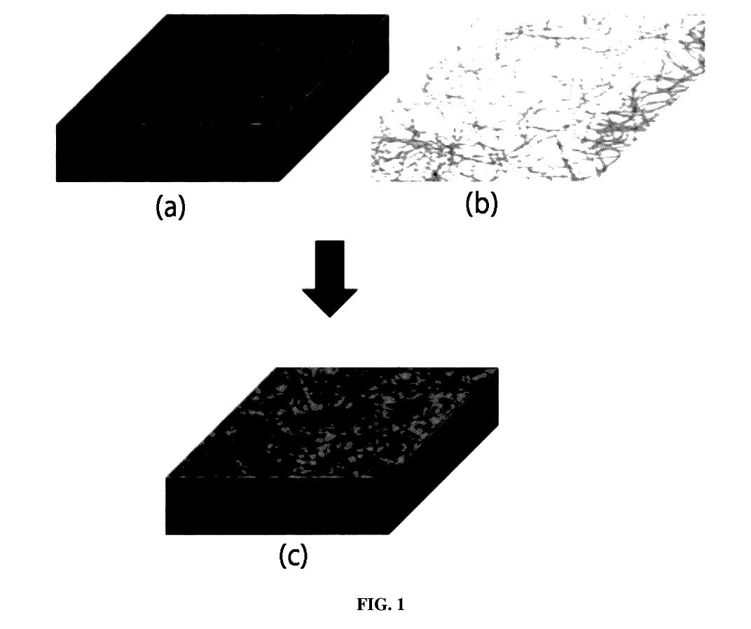

According to a preferred embodiment of the present invention, FIG. 1 shows (a) an exemplary carbon fiber, (b) an exemplary conductive metal-plated carbon fiber and (c) an exemplary carbon fiber composite according to an exemplary embodiment of the present invention. FIG. 1 shows that (c) the carbon fiber composite may be prepared by mixing (a) the carbon fiber and (b) the conductive metal-plated carbon fiber, preparing the carbon fiber reinforcement material in the form of a three-dimensional non-woven fabric, and then impregnating a matrix resin thereon.

Preferably, the carbon fiber may have average fiber length of about 1 to 70 mm. Specifically, when the fiber length is less than about 1 mm, reinforcing effect may be significantly reduced, and when it is greater than about 70 mm, workability may be reduced because fibers get tangled.

The metal of the conductive metal-plated carbon fiber may be at least one selected from the group consisting of copper (Cu), zinc (Zn), silver (Ag), gold (Au), platinum (Pt), antimony (Sb), manganese (Mn), nickel (Ni), vanadium (V), indium (In) and tin (Sn). The conductivity of the aforementioned metal may be preferably as much as that of steel or greater. Thus, lightning current may run along a vehicle shell when lightning occurs, thereby increasing stability.

The conductive metal may have average thickness of about 0.1 to 0.5 μm. When the thickness is less than about 0.1 μm, the molded part may not have sufficient conductivity to prevent lightning, and there may be a risk of heating, when lightning occurs, due to increased resistance. When it is greater than about 0.5 μm, processing and weight reduction may not be sufficient because weight is increased, and internal stress may be generated by external temperature change caused by difference of linear expansion coefficient.

The carbon fiber reinforcement material may be in the form of a three-dimensional non-woven fabric.

The matrix resin may be a thermosetting resin that may be at least one selected from the group consisting of epoxy, urethane, vinyl ester, unsaturated polyester and urethane acrylate. Further, the matrix resin may be a thermoplastic resin comprising nylon, polymethylmethacrylate (PMMA) or a mixture thereof. The carbon fiber composite may comprise the carbon fiber in an amount of about 10 to 30 volume %, the conductive metal-plated carbon fiber in an amount of about 10 to 50 volume % and the matrix resin in an amount of about 40 to 60 volume %, all the volume % based on the total volume of the carbon fiber composite.

Particularly, in the conductive metal-plated carbon fiber, the metal surface may be generally formed by an electroless plating process, and the conductive metal can be plated on the surface of the carbon fiber by continuously passing through a plating bath containing anode as a carbon fiber has conductor properties.

When the content of the conductive metal-plated carbon fiber is less than about 10 volume %, electrical conductivity may deteriorate because a conductive path is not formed, and when it is greater than about 50 volume %, weight reduction may not be sufficient because weight of the carbon fiber composite is increased. In particular, the content may be 25 to 35 volume %.

The method for preparing the carbon fiber composite having high conductivity of the present invention may include: preparing a carbon fiber reinforcement material by steps comprising mixing a carbon fiber and a conductive metal-plated carbon fiber, thereby; and preparing the carbon fiber composite by steps comprising impregnating a matrix resin on the carbon fiber reinforcement material and then molding thereof. The carbon fiber composite may comprise the carbon fiber in an amount of about 10 to 30 volume %, the conductive metal-plated carbon fiber in an amount of about 10 to 50 volume % and the matrix resin in an amount of about 40 to 60 volume %, all the volume % based on the total volume of the carbon fiber composite.

The molding may be conducted by wet compression molding. For example, the matrix resin may be coated on the carbon fiber reinforcement material settled on the mold followed by compressing the mold for molding, or Sheet Molding Compound (SMC) process.

The present invention provides a molded body prepared by using the carbon fiber composite. For example, the molded body may be a lightweight roof for a vehicle.

Further, the present invention provides vehicles that comprise the molded body comprising the carbon fiber composite.

Accordingly, the present invention may prevent risk of lightning due to its high conductivity by applying the carbon fiber reinforcement material, which is the mixture of the carbon fiber and the conductive metal-plated carbon fiber. Further, it may achieve lightweight by using the carbon fiber. Additionally, when it is applied to a vehicle shell, for example, a roof, it may improve fuel efficiency by weight reduction of a vehicle as well as driving performance by lowering center of gravity.

### EXAMPLES

The following examples illustrate the invention and are not intended to limit the same.

### Example 1

A carbon fiber composite non-woven fabric comprising a carbon fiber of 20 volume % and a nickel-plated carbon fiber of 30 volume % was prepared in the form of a three-dimensional non-woven fabric for a roof shape. A nickel-plated carbon fiber having average thickness of 0.22 μm was used for the nickel-plated carbon fiber, and average fiber length of the carbon fiber was 50 mm.

According to circumstances, when manufacturing the non-woven fabric, in the case of using a needle punching or water jet method, dimensional stability of the non-woven fabric may be provided by mixing the epoxy resin in an amount of 3 volume %, based on the total carbon fiber weight in order to prevent the carbon fiber from damaging. An epoxy resin of 50 volume % as a matrix resin was impregnated on the carbon fiber non-woven fabric (mat), and then the mold was closed for molding.

At this time, a mold temperature was set to 120° C., and after the epoxy resin was hardened, the mold was unloaded. After unloading was completed, when there was the overflowed epoxy resin, which was coated in an excessive amount than size of the part. The overflowed resin may be cut and trimed. Finally, a carbon fiber composite roof of a vehicle having size of 1220 mm×1280 mm×1.8 mm was prepared.

### Example 2

The procedure of Example 1 was repeated except for mixing an epoxy resin of 60 volume % as a matrix resin with a carbon fiber reinforcement material that included a carbon fiber of 20 volume % and a nickel-pated carbon fiber of 20 volume %, to prepare a carbon fiber composite roof for a vehicle.

### Example 3

The procedure of Example 1 was repeated except for mixing a copper-plated carbon fiber of 30 volume % instead of the nickel-plated carbon fiber to prepare a carbon fiber composite roof for a vehicle.

### Example 4

The procedure of Example 1 was repeated except for mixing a nickel-plated carbon fiber having an average thickness of the plated nickel of 0.1 μm, to prepare a carbon fiber composite roof for a vehicle.

### Example 5

The procedure of Example 1 was repeated except for mixing a nickel-plated carbon fiber having an average thickness of the plated nickel of 0.5 μm, to prepare a carbon fiber composite roof for a vehicle.

### Comparative Example 1

The procedure of Example 1 was repeated except for using a steel plate having the same size of 1220 mm×1280 mm×1.8 mm and thickness of about 0.7 mm to prepare a roof for a vehicle.

### Comparative Example 2

The warp (or weft) of the woven carbon fiber reinforcement material was chosen as a main direction, and based thereon, the carbon fiber of 50 volume % was premolded as the mold shape in the form of 0°, 90°, 45°, −45°, −45°, 45°, 90°, 0° [0°/90°/45°/−45°]ₛ, respectively, and then settled in a mold. Then the epoxy resin of 55 volume % was injected to the mold settled with the carbon fiber, and the mold was closed at a temperature of 120° C. followed by molding and unloading it. After unloading was completed, when there was the overflowed epoxy resin, which was coated in an excessive amount than size of the part, the overflowed resin may be cut and trimed. Finally, a carbon fiber composite roof of a vehicle having size of 1220 mm×1280 mm×1.8 mm was prepared.

### Comparative Example 3

The procedure of Comparative Example 2 was repeated except for manufacturing the roof by inserting a mesh layer having areal weight of 317 g/m², which was woven with a steel wire having diameter of 55 μm, to the carbon fiber of 50 volume % of Comparative Example 2.

### Comparative Example 4

The procedure of Comparative Example 3 was repeated except for manufacturing the roof by inserting a copper mesh layer having area weight of 364 g/m².

### Comparative Example 5

The procedure of Comparative Example 2 was repeated except for manufacturing the roof by dispersing a multi-wall carbon nanotube (MWNT) of 0.5 volume % to the epoxy resin.

### Comparative Example 6

The procedure of Comparative Example 2 was repeated except for manufacturing the roof by adhering an aluminum thin plate having thickness of 30 μm to a 2.5 mm-thick composite material roof manufactured by using a glass fiber.

### Test Example

For the vehicle roofs manufactured in Examples 1 to 5 and Comparative Examples 1 to 6, physical properties were measured, and the results were shown in the following Tables 1 and 2.

TABLE 1

| | Example 1 | Example 2 | Example 3 | Example 4 | Example 5 |
|---|---|---|---|---|---|
| Section | Ni-plated CF | Ni-plated CF | Cu-plated CF | Ni-plated CF | Ni-plated CF |
| Weight*¹⁾ (g) | 4,866 | 4,638 | 4,872 | 4,510 | 5,576 |
| Resistance*²⁾ | 8.7 × 10⁻⁸ | 9.5 × 10⁻⁸ | 2.8 × 10⁻⁸ | 1.6 × 10⁻⁶ | 4.6 × 10⁻⁸ |
| (Ω · m) | | | | | |
| Torsional | 5,300 | 5,300 | 5,100 | 5,400 | 4,900 |
| Rigidity*¹⁾ | | | | | |
| (kgf · m²/rad) | | | | | |
| Linear | 12.7 | 12.6 | 13.4 | 12.5 | 14.4 |
| Expansion | | | | | |
| Coefficient | | | | | |
| (10⁻⁶ m/m · K) | | | | | |

^{*1)}Based on one piece of a car roof having projected Area of 1222 mm × 1268 mm,
^{*2)}Resistance of Conductive Layer

TABLE 2

| | | Comp. | Comp. | Comp. | | Comp. |
|---|---|---|---|---|---|---|
| | Comp. | Example 2 | Example 3 | Example 4 | Comp. | Example 6 |
| | Example 1 | Untreated | Steel | Copper | Example 5 | GFRP + |
| Section | Steel | CF | Mesh | Mesh | CNT | Al Foil |
| Weight*¹⁾ (g) | 8,500 | 4,184 | 4,675 | 4,748 | 4,185 | 6,996 |
| Resistance*²⁾ | 1.1 × 10⁻⁷ | 5.2 × 10⁻⁴ | 1.3 × 10⁻⁷ | 1.7 × 10⁻⁸ | 3 × 10⁻¹ | 3.1 × 10⁻⁸ |
| (Ω · m) | | | | | | |
| Torsional | 4,000 | 5,700 | 5,750 | 5,600 | 5,800 | 4,200 |
| Rigidity*¹⁾ | | | | | | |
| (kgf · m²/rad) | | | | | | |
| Linear | 13.0 | 2.1 | 2.3 | 2.4 | 2.1 | 18.6 |
| Expansion | | | | | | |
| Coefficient | | | | | | |
| (10⁻⁶ m/m · K) | | | | | | |

*¹⁾Based on one piece of a car roof having projected Area of 1222 mm × 1268 mm,
*²⁾Resistance of Conductive Layer

According to the results of Tables 1 and 2, it is confirmed that Examples 1 to 5 had stronger torsional rigidity than the steel specification, although their weight were reduced about 52%, as compared to Comparative Example 1 including conventional components. Further, through the resistance value, high conductivity could be obtained by forming a conductive path using the conductive metal such as nickel and copper having better conductivity than the conventional steel components. The linear expansion coefficient means percentage of length change according to thermal expansion of solid (temperature change), and showed percentage similar to the steel. Through this, it could be found that stress at the interface could be minimized.

On the contrary, it could be found that, as compared to Examples 1 to 5, Comparative Example 1 had unfavorable fuel efficiency and driving performance because is was twofold heavier, and Comparative Example 2 had stronger weight and torsional rigidity, but had thousands fold or greater electrical resistance than the existing steel specification, thereby having risk of heating when lightning.

Further, Comparative Examples 3 and 4 had high conductivity and strong torsional rigidity, but linear expansion coefficients were different from the steel vehicle body. Thus, it can be confirmed that stress may be formed by external temperature change, and delamination and fatigue failure may occur by repeated load of the metal mesh inserted in the middle.

Comparative Example 5 had low conductivity and unfavorable reproducibility because dispersion control of the CNT was not easy, and Comparative Example 6 embodied torsional rigidity similar with the existing steel by using a glass fiber to avoid potential corrosion of aluminum and the carbon fiber. However, it could be found that the weight reducing effect was not large as compared to Examples 1 and 2, and there may be a problem that a level difference may be generated from the neighboring parts as thickness was increased largely. Thus, it was confirmed that the vehicle roofs manufactured by the carbon fiber composites, for example, the vehicle roofs prepared in Examples 1 to 5, are lightweighted as compared to the existing steel, and have greater conductivity.

Accordingly, the carbon fiber composite according to the present invention may prevent risk of lightning due to its high conductivity by applying the carbon fiber reinforcement material that comprises the carbon fiber and the conductive metal-plated carbon fiber.

Further, it may achieve weight reduction by using the carbon fiber, and when it is applied to a vehicle shell, in particular, a roof, it may improve fuel efficiency by weight reduction of a vehicle as well as driving performance by lowering center of gravity

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A carbon fiber composite comprising:
a carbon fiber reinforcement material comprising a carbon fiber and a conductive metal-plated carbon fiber, and
a matrix resin impregnated on the carbon fiber reinforcement material.

2. The carbon fiber composite of claim 1, wherein the carbon fiber has average fiber length of about 1 to 70 mm.

3. The carbon fiber composite of claim 1, wherein a metal of the conductive metal-plated carbon fiber is at least one selected from the group consisting of copper (Cu), zinc (Zn), silver (Ag), gold (Au), platinum (Pt), antimony (Sb), manganese (Mn), nickel (Ni), vanadium (V), indium (In) and tin (Sn).

4. The carbon fiber composite of claim 1, wherein the conductive metal has average thickness of about 0.1 to 0.5 μm.

5. The carbon fiber composite of claim 1, wherein the carbon fiber reinforcement material is in the form of a three-dimensional non-woven fabric.

6. The carbon fiber composite of claim 1, wherein the matrix resin is a thermosetting resin that is at least one selected from the group consisting of epoxy, urethane, vinyl ester, unsaturated polyester and urethane acrylate.

7. The carbon fiber composite of claim 1, wherein the matrix resin is a thermoplastic resin comprising nylon, polymethylmethacrylate (PMMA) or a mixture thereof.

8. The carbon fiber composite of claim 1, which comprises the carbon fiber in an amount of about 10 to 30 volume %, the conductive metal-plated carbon fiber in an amount of about 10 to 50 volume % and the matrix resin in an amount of about 40 to 60 volume %, all the volume % based on the total volume of the carbon fiber composite.

9. A method for preparing a carbon fiber composite comprising:
preparing a carbon fiber reinforcement material by steps comprising mixing a carbon fiber and a conductive metal-plated carbon fiber; and
preparing the carbon fiber composite by steps comprising impregnating a matrix resin on the carbon fiber reinforcement material and then molding thereof.

10. The method of claim 9, wherein the carbon fiber composite comprises the carbon fiber in an amount of about 10 to 30 volume %, the conductive metal-plated carbon fiber in an amount of about 10 to 50 volume % and the matrix resin in an amount of about 40 to 60 volume %, all the volume % based on the total volume of the carbon fiber composite.

11. The method of claim 9, wherein the molding is conducted by wet compression molding or Sheet Molding Compound (SMC) process.

12. A molded body comprising a carbon fiber composite of claim 1.

13. The molded body of claim 12 is a lightweight roof for a vehicle.

14. A vehicle comprising a molded body of claim 12.
